(19) United States
(12) Patent Application Publication
(10) Pub. No.: US 2026/0154834 A1
(43) Pub. Date: Jun. 4, 2026

(54) ELECTRONIC DEVICE FOR ENHANCING IMAGE QUALITY AND CONTROL METHOD THEREOF

(71) Applicant: SAMSUNG ELECTRONICS CO., LTD., Suwon-si (KR)

(72) Inventors: Bongjoe KIM, Suwon-si (KR); Donghyun KIM, Suwon-si (KR); Jongho KIM, Suwon-si (KR); Jonghwan KIM, Suwon-si (KR); Guiwon SEO, Suwon-si (KR); Minjae LEE, Suwon-si (KR)

(73) Assignee: SAMSUNG ELECTRONICS CO., LTD., Suwon-si (KR)

(21) Appl. No.: 19/374,568

(22) Filed: Oct. 30, 2025

Related U.S. Application Data
(63) Continuation of application No. PCT/KR2025/014109, filed on Sep. 10, 2025.

(30) Foreign Application Priority Data
Nov. 29, 2024 (KR) 10-2024-0175626

(51) Int. Cl. G06T 7/50; G06T 5/40; G06T 5/60; G06T 5/73; G06T 5/94; G06V 10/25; G06V 10/26

(52) U.S. Cl. CPC G06T 7/50; G06T 5/40; G06T 5/60; G06T 5/73; G06T 5/94; G06V 10/25; G06V 10/26; G06T 2207/20084

(57) ABSTRACT

A display device including a display, memory storing instructions, and at least one processor is provided. The instructions, when executed by the at least one processor individually or collectively, cause the electronic device to identify a first object-of-interest region having a minimum depth value among a plurality of object-of-interest regions identified in an input image, normalize depth values of the plurality of object-of-interest regions based on a first depth value of the first object-of-interest region, and acquire a normalized depth map corresponding to the input image based on the normalized depth values of the plurality of object-of-interest regions, acquire an output image by image-processing the input image based on the normalized depth map and display the acquired output image on the display.

### CROSS-REFERENCE TO RELATED APPLICATION(S)

This application is a bypass continuation of International Application No. PCT/KR 2025/014109, filed on Sep. 10, 2025, which is based on and claims priority to Korean Patent Application No. 10-2024-0175626, filed on Nov. 29, 2024, in the Korean Intellectual Property Office, the disclosures of which are incorporated by reference herein in their entireties.

### BACKGROUND

### 1. Field

This disclosure relates to an electronic device for enhancing image quality and a control method therefor.

### 2. Description of Related Art

With the advancement in electronic technologies, various types of electronic devices have been developed and supplied. In particular, advancements have been made in the area of display devices that are used in places such as a home, an office, a public place and the like.

Recently, depth information or main object information of an image have been used to enhance image quality.

The above descriptions may be provided as related art for a better understanding of the subject matter of the disclosure. No admission, argument or determination is raised as to whether any of the descriptions is applicable as prior art associated with the disclosure.

### SUMMARY

According to an aspect of the disclosure, there is provided an electronic device including: a display, memory storing instructions and at least one processor, wherein the instructions, when executed by the at least one processor individually or collectively, cause the electronic device to: identify a first object-of-interest region having a minimum depth value among a plurality of object-of-interest regions identified in an input image; normalize depth values of the plurality of object-of-interest regions based on a first depth value of the first object-of-interest region, and acquire a normalized depth map corresponding to the input image based on the normalized depth values of the plurality of object-of-interest regions; acquire an output image by image-processing the input image based on the normalized depth map; and display the acquired output image on the display.

The instructions, when executed by the at least one processor individually or collectively, may further cause the electronic device to: acquire the first depth value of the first object-of-interest region based on a minimum depth value of the first object-of-interest region, and acquire the normalized depth map by re-setting depth values of remaining regions except for the first object-of-interest region based on the normalized depth values.

The instructions, when executed by the at least one processor individually or collectively, may further cause the electronic device to: acquire the normalized depth map by re-setting, as a depth value identical with the depth values of the plurality of object-of-interest regions, a depth value of a region of which a depth value is greater than the minimum depth value among the remaining regions.

The instructions, when executed by the at least one processor individually or collectively, may further cause the electronic device to: acquire the normalized depth map by re-setting, as a depth value identified based on a ratio of a depth value of a region of which a depth value is less than the minimum depth value among the remaining regions to the minimum depth value, the depth value of the region.

The instructions, when executed by the at least one processor individually or collectively, may further cause the electronic device to: acquire a semantic segmentation map including pixel position information corresponding to the plurality of object-of-interest regions by inputting the input image to a first artificial intelligence model; acquire a depth map including a depth value of each pixel in the input image by inputting the input image to a second artificial intelligence model; and identify the first object-of-interest region having the minimum depth value among the plurality of object-of-interest regions based on the semantic segmentation map and the depth map.

The instructions, when executed by the at least one processor individually or collectively, may further cause the electronic device to: identify object-of-interest depth values corresponding to pixels in the plurality of object-of-interest regions in the depth map, based on the pixel position information of the plurality of object-of-interest regions identified in the semantic segmentation map; identify a depth value histogram including a depth value distribution corresponding to each of the plurality of object-of-interest regions based on the object-of-interest depth values; and identify a depth value corresponding to each of the plurality of object-of-interest regions based on the depth value histogram.

The instructions, when executed by the at least one processor individually or collectively, may further cause the electronic device to: identify an average depth value of each of the plurality of object-of-interest regions based on the depth value histogram; and identify, as the depth value corresponding to each of the plurality of object-of-interest regions, the respective average depth value.

The instructions, when executed by the at least one processor individually or collectively, may further cause the electronic device to: acquire the normalized depth map by inputting the input image to a third artificial intelligence model, and wherein the third artificial intelligence model is trained to identify an object-of-interest region having a minimum depth value among a plurality of object-of-interest regions identified in the input image, to normalize the depth values of the plurality of object-of-interest regions based on the minimum depth value of the first object-of-interest region, and to output the normalized depth map.

The instructions, when executed by the at least one processor individually or collectively, may further cause the electronic device to: acquire the output image by differentially processing at least one of contrast, saturation or sharpness of the input image for each region based on the normalized depth map.

According to another aspect of the disclosure, there is provided a control method of an electronic device, the method including: identifying a first object-of-interest region having a minimum depth value among a plurality of object-of-interest regions identified in an input image; normalizing depth values of the plurality of object-of-interest regions based on a first depth value of the first object-of-interest region, and acquiring a normalized depth map corresponding to the input image based on the normalized depth values of the plurality of object-of-interest regions; acquiring an output image by image-processing the input image based on the normalized depth map; and displaying the acquired output image on a display.

The acquiring the normalized depth map may include: acquiring the first depth value of the first object-of-interest region based on a minimum depth value of the first object-of-interest region, and acquiring the normalized depth map by re-setting depth values of remaining regions except for the first object-of-interest region based on the normalized depth values.

The acquiring the normalized depth map may include: acquiring the normalized depth map by re-setting, as a depth value identical with the depth values of the plurality of object-of-interest regions, a depth value of a region of which a depth value is greater than the minimum depth value among the remaining regions.

The acquiring the normalized depth map may include acquiring the normalized depth map by re-setting, as a depth value identified based on a ratio of a depth value of a region of which a depth value is less than the minimum depth value among the remaining regions to the minimum depth value, the depth value of the region.

The identifying the object-of-interest region having the minimum depth value may include: acquiring a semantic segmentation map including pixel position information corresponding to the plurality of object-of-interest regions by inputting the input image to a first artificial intelligence model; acquiring a depth map including a depth value of each pixel in the input image by inputting the input image to a second artificial intelligence model; and identifying the object-of-interest region having the minimum depth value among the plurality of object-of-interest regions based on the semantic segmentation map and the depth map.

According to another aspect of the disclosure, there is provided a non-transitory computer readable medium storing computer instructions, wherein the instructions, when executed by a processor of an electronic device, cause the electronic device to perform operations, the operations including: identifying a first object-of-interest region having a minimum depth value among a plurality of object-of-interest regions identified in an input image; normalizing depth values of the plurality of object-of-interest regions based on a first depth value of the first object-of-interest region, and acquiring a normalized depth map corresponding to the input image based on the normalized depth values of the plurality of object-of-interest regions; acquiring an output image by image-processing the input image based on the normalized depth map; and displaying the acquired output image on a display.

### BRIEF DESCRIPTION OF DRAWINGS

Above-describe features and other features according to embodiments of the disclosure may be understood more clearly from following descriptions provided with reference to accompanying drawings, wherein:

FIGS. 1A, 1B and 1C are views provided to explain examples of depth information-based image processing and object of interest-based image processing;

FIG. 2A is a block diagram illustrating one example of a configuration of an electronic device according to one embodiment;

FIG. 2B is a block diagram illustrating one example of a configuration of an electronic device according to one or more embodiments;

FIG. 3 is a flowchart provided to explain one example of a control method of an electronic device according to one embodiment;

FIG. 4 is a view provided to explain an acquisition method of a normalized depth map according to one embodiment;

FIG. 5 is a view provided to explain an acquisition method of a normalized depth map according to one embodiment;

FIG. 6 is a view provided to explain an image processing method using normalized depth information according to one embodiment;

FIGS. 7A, 7B and 7C are views provided to explain an image processing effect using normalized depth information according to one embodiment;

FIGS. 8A, 8B and 8C are views provided to explain an image processing effect using normalized depth information according to one embodiment; and

FIGS. 9A, 9B and 9C are views provided to explain an image processing effect using normalized depth information according to one embodiment.

### DETAILED DESCRIPTION

Hereafter, the subject matter of the disclosure is described with reference to the accompanying drawings.

General terms currently used in the embodiments of the disclosure in consideration of their functions in the disclosure, but may be changed based on the intention of those skilled in the art or a judicial precedent, the emergence of a new technology, or the like. In addition, in a specific case, terms arbitrarily chosen by the applicant may be included in the terms used herein. In this case, the meanings of such terms are described in detail in the detailed description of the disclosure. Therefore, the terms used in the disclosure need to be defined based on meanings thereof and particulars throughout the disclosure rather than simply names thereof.

In the disclosure, the expression “have”, “may have”, “include”, or “may include” indicates the existence of a feature (e.g., a numerical value, a function, an operation or an element such as a part), and does not exclude the existence of an additional feature.

The expression of at least one from A or/and B is to be understood as indicating any one of “A” or “B” or “A and B”.

The expression “1st”, “2nd”, “first”, or “second”, used in the disclosure, may be used to refer to various elements regardless of their order and/or importance, and may be used merely to differentiate one element from another but not intended to limit the elements.

Based on one element (e.g., a first element) referred to as being “(operatively or communicatively) coupled with/to or connected with/to” another element (e.g., a second element), it is to be understood that one element may connect to another element directly, or through yet another element (e.g., a third element).

In the disclosure, singular forms include plural forms as well, unless explicitly indicated otherwise. In the disclosure, the term “include” or “comprised of” and the like specify the presence of stated features, numbers, steps, operations, elements, components or combinations thereof but do not imply the exclusion of the presence or addition of one or more other features, numbers, steps, operations, elements, components or combinations thereof.

In the disclosure, the term “module” or “unit” may perform at least one function or operation, and be implemented by hardware or software or by a combination of hardware and software. In addition, a plurality of “modules” or a plurality of “units” may be integrated into at least one module and be implemented by at least one processor except for a “module” or a “unit” that needs to be implemented by specific hardware.

In the disclosure, the term “user” may refer to a person using an electronic device or a device (e.g., an artificial intelligence electronic device) using an electronic device.

In the drawings, various elements and regions are schematically illustrated. Accordingly, the technical spirit of the disclosure is not limited by a relative size or gap drawn in the drawings.

Hereafter, the embodiments of the disclosure are specifically described with reference to the accompanying drawings.

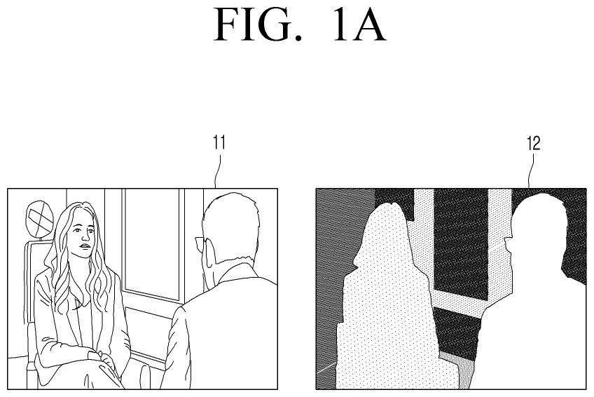

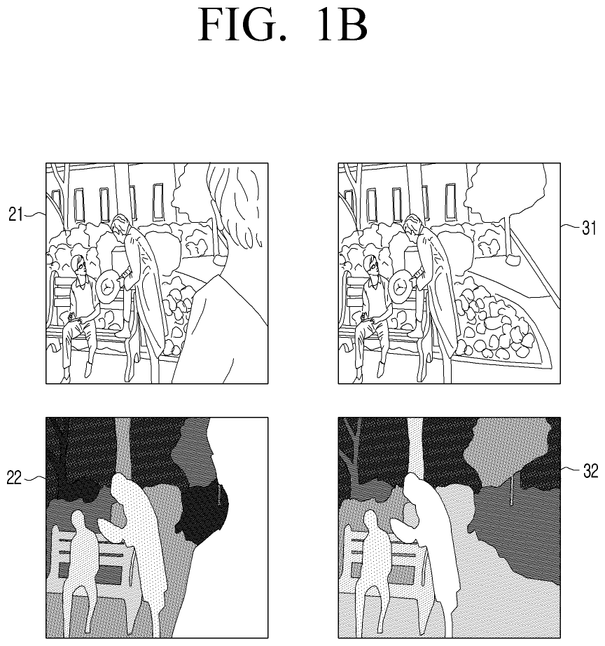

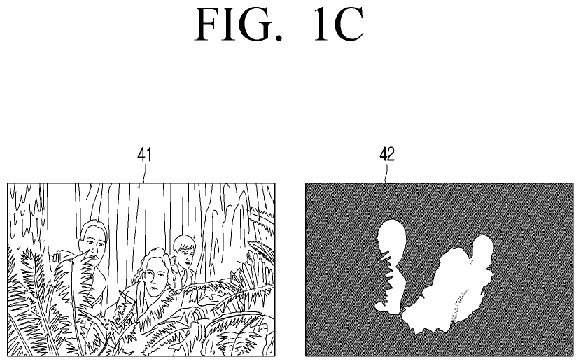

FIGS. 1A, 1B and 1C are views provided to explain examples of depth information-based image processing and object of interest-based image processing.

FIG. 1A and FIG. 1B are views provided to explain a depth information-based image processing method according to one embodiment.

The depth information-based image processing method according to one embodiment may involve estimating depth information in an input image, and based on the estimated depth information, differentiating the input image into a foreground layer, a middle layer and a background layer to perform image processing. For example, the image processing may be performed step by step based on a depth of each layer.

As one example, in the depth information-based image processing method, image processing results unintended or undesired by the producer may occur. For example, as illustrated in FIG. 1A, in an input image 11, the sharpness, color and brightness of a background character may be emphasized by placing a focus on the background character rather than a foreground character to emphasize the background character, according to the intention of the image producer. However, in an example case where depth information 12 is only used, the image quality of the foreground character is emphasized while the image quality of the background character is de-emphasized, producing image processing results against the intention of the producer.

As one example, in the depth information-based image processing method, an unwanted change may occur to the depth information in an example case where an object appears and then disappears on the same scene. This is because relative depth information estimated in the input image is information relatively indicating that an object is further forward than a surrounding object or further backward than a surrounding object rather than estimated absolute depth information of objects. For example, as illustrated in FIG. 1B, since an object is in the foreground in an earlier frame 21 (e.g., a 0^{th} frame), two men relatively correspond to the middle ground in depth information 22. However, since no object in the foreground in a later frame 31 (e.g., a 98^{th} frame), two men relatively correspond to the foreground in depth information 32. Such a change in the relative depth information on the same scene causes an unwanted change in image quality in the same way.

FIG. 1C is a view provided to explain a depth information-based image processing method according to one embodiment.

An object of interest-based image processing method according to one embodiment may involve estimating an object of interest (or an important object) in an input image, and then performing differential image quality control based on an object-of-interest region and a remaining region, to perform object of interest-oriented image processing. Here, the object-of-interest region may correspond to the object of interest (or the important object) in the input image.

As one example, in the object of interest-based image processing method, since image processing is performed regardless of relative depth information between objects in an image, cognitive dissonance may occur. For example, in an example case where image processing is performed based on object-of-interest information 42 corresponding to an input image 41 as illustrated in FIG. 1C, the object of interest in the background is emphasized further than the foreground, causing cognitive dissonance in which a relative depth value is inverted.

Hereafter, described are various embodiments securing improvement in the cognitively harmonious image quality and three dimensionality of a 2D image by combining object-of-interest information and relative depth information.

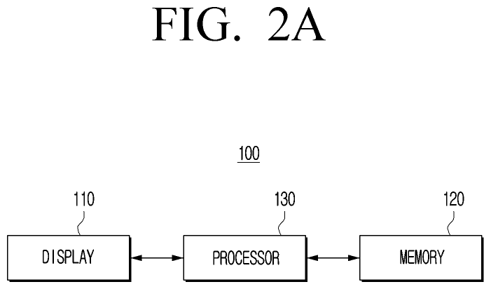

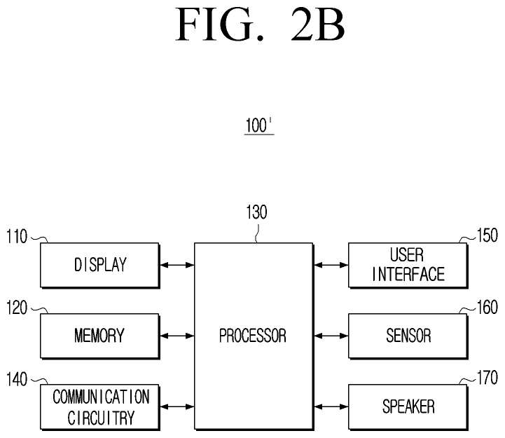

FIG. 2A is a block diagram illustrating one example of a configuration of an electronic device according to one embodiment.

Referring to FIG. 2A, an electronic device 100 may include a display 110, memory 120 and at least one processor 130. However, the disclosure is not limited thereto, and as such, the electronic device 100 may include one or more other components.

The display 110 may be implemented as a display including a self light emitting element, or a display including a non-self light emitting element and backlight. For example, the display 110 may be implemented as various types of displays such as a liquid crystal display (LCD), an organic light emitting diode (OLED) display, a light emitting diode (LED), a micro LED, a mini LED, a plasma display panel (PDP), a quantum dot (QD) display, a quantum dot light-emitting diode and the like. In the display 110, driving circuitry implementable in the form of an a-si TFT, a low temperature poly silicon (LTPS) TFT, an organic TFT (OTFT) and the like, and a backlight unit may be included together. As one example, the display 110 may be implemented to have a touch sensor on the front surface thereof such that the touch sensor sensing a touch operation in the form of a touch film, a touch sheet, a touch pad and the like, senses various types of touch inputs. For example, the display 110 may sense various types of touch inputs such as a touch input by the user, a touch input by an input device such as a stylus pen, a touch input by a specific electrostatic material and the like. Herein, the input device may be implemented as a pen-type input device that may be referred to as various terms such as an electronic pen, a stylus pen, an S-pen and the like. As one example, the display 110 may be implemented as a flat display, a curved display, a foldable display or/and a rollable display and the like.

The memory 120 may store data needed for various embodiments. The memory 120 may be implemented in the form of memory embedded in an electronic device 100′ or in the form of memory detachable from an electronic device 100 depending on a data storage purpose. In an example case in which data is for driving the electronic device 100, the data may be stored in the memory embedded in the electronic device 100', and in an example case in which data is for an expansion function of the electronic device 100, the data may be stored in memory detachable from the electronic device 100. Meanwhile, the memory embedded in the electronic device 100 may be implemented in the form of at least one of volatile memory (e.g., dynamic RAM (DRAM), static RAM (SRAM) or synchronous dynamic RAM (SDRAM), and the like), or non-volatile memory (e.g., one time programmable ROM (OTPROM), programmable ROM (PROM), erasable and programmable ROM (EPROM), electrically erasable and programmable ROM (EEPROM), mask ROM, flash ROM, flash memory (e.g., NAND flash or NOR flash, and the like), hard drive, or solid state drive (SSD)). Additionally, the memory detachable from the electronic device 100′ may be implemented in the form of a memory card (e.g., compact flash (CF), secure digital (SD), micro secure digital (Micro-SD), mini secure digital (Mini-SD), extreme digital (xD), a multi-media card (MMC) and the like), external memory (e.g., USB memory) connectable to a USB port, and the like.

As one example, the memory 120 may store a computer program including at least one instruction or instructions for controlling the electronic device 100.

As another example, the memory 120 may store an image (e.g., an input image) received from an external device (e.g., a source device), an external storage medium (e.g., a USB), an external server (e.g., webhard) and the like. In another example, the memory 120 may store an image acquired through a camera provided in the electronic device 100.

As yet another embodiment, the memory 120 may store various types of information needed for image processing, such as information, algorithm, an image quality parameter and the like for performing at least one of noise reduction, detail enhancement, tone mapping, contrast enhancement, color enhancement or frame rate conversion.

According to one embodiment, the memory 120 may be implemented in the form of single memory storing data generated in various operations according to the disclosure. However, according to another embodiment, the memory 120 may also be implemented to include a plurality of memories storing different types of data respectively, or storing data generated in different steps respectively.

In the above-described embodiments, various types of data are stored in external memory 120 of the processor 130, but at least part of the above-described data may also be stored in memory in the processor 130 based on an embodiment of at least one of the electronic device 100 or the processor 130.

The at least one processor 130 controls operations of the electronic device 100 entirely. Specifically, the at least one processor 130 may control the operations of the electronic device 100 entirely by being connected with each element of the electronic device 100. For example, the at least one processor 130 may control the entire operations of the electronic device 100 by being connected with the display 110 and memory 120 electrically. The at least one processor 130 may include one processor or a plurality of processors.

The at least one processor 130 may perform the operations of the electronic device 100 according to various embodiments, by executing at least one instruction stored in the memory 120.

As one example, functions in association with artificial intelligence according to the disclosure may be performed through the processor and memory of the electronic device.

The at least one processor 130 may include one processor or a plurality of processors. At this time, one processor or the plurality of processors may include at least one of a central processing unit (CPU), a graphics processing unit (GPU), and a neural processing unit (NPU), but not be limited thereto.

The CPU, as a general purpose processor capable of performing an AI computation as well as a normal computation, may efficiently execute a complex program through a multi-level cache structure. The CPU is advantageous in a series processing method enabling an organic connection between previous calculation results and following calculation results through a consecutive calculation. The general purpose processor is not limited to the above-described examples, unless explicitly indicated as the above-described CPU.

The GPU, as a processor for a massive computation such as a floating-point computation and the like used to process graphics, may perform a massive computation in parallel by integrating cores in massive amounts. In particular, the GPU may be more advantageous in a parallel processing method such as a convolution computation and the like than the CPU. Additionally, the GPU may be used as a co-processor for complementing a function of the CPU. A processor for a massive computation is not limited to the above-described examples, unless explicitly indicated as the above-described GPU.

The NPU, as a processor specializing in an AI computation using an artificial neural network, may be implemented in the way that each layer constituting an artificial neural network is implemented with hardware (e.g., silicon). At this time, since the NPU is designed specially according to specifications required by a business, a freedom degree of the NPU is less than that of the CPU or the GPU, but the NPU may process an AI computation required by a business efficiently. Meanwhile, as a processor specializing in an AI computation, the NPU may be implemented in various forms such as a tensor processing unit (TPU), an intelligence processing unit (IPU), a vision processing unit (VPU) and the like. An artificial intelligence processor is not limited to the above examples, unless explicitly indicated as the above-described NPU.

Additionally, the at least one processor 130 may be implemented as a system on a chip (SoC). At this time, the at least one processor 130 may further include memory 120, and a network interface such as a bus and the like for data communication between the processor 130 and the memory 120 in the SoC.

In an example case in which a plurality of processors are included in a system on a chip (SoC) included in the electronic device 100, the electronic device 100 may perform an artificial intelligence-relating computation (e.g., a computation in association with learning or inference of an artificial intelligence model) by using part of the plurality of processors. For example, the electronic device may perform an AI-relating computation by using at least one of a GPU, an NPU, a VPU, a TPU, and a hardware accelerator specializing in an AI computation such as a convolution computation, a matrix multiplication computation and the like, among the plurality of processors. However, this is provided merely as one or more embodiments, and certainly, an AI-relating computation may be processed by using the CPU and the like and a general purpose processor.

Additionally, the electronic device 100 may perform a computation in association with an AI-relating function by using a multi core (e.g., a dual core, a quad core and the like) included in one processor. In particular, the electronic device may perform an AI computation in parallel such as a convolution computation, a matrix multiplication computation and the like by using a multi core included in the processor.

The at least one processor 130 may perform control to process input data, according to a predefined operation rule or an artificial intelligence model (or a neural network model or a learning network) that is stored in the memory 120. The predefined operation rule or the artificial intelligence model is characterized in that the predefined operation rule or the artificial intelligence model is made through learning.

Herein, making the predefined operation rule or the artificial intelligence model through learning denotes making a predefined operation rule or an artificial intelligence model of a desired feature, by applying a learning algorithm to large numbers of learning data. Such learning may be performed in a device itself in which artificial intelligence according to the disclosure is performed, or performed through a separate server/system.

The artificial intelligence model may include a plurality of neural network layers. At least one layer has at least one weight value, and a computation of layer is performed through results of a computation of a previous layer and at least one defined computation. Examples of the neural network may include a convolutional neural network (CNN), a recurrent neural network (RNN), a deep neural network (DNN), a restricted boltzmann machine (RBM), a deep belief network (DBN), a bidirectional recurrent deep neural network (BRDNN), and a deep Q-network, and a transformer, but the neural network in the disclosure is not limited to the above example, unless explicitly stated otherwise.

The learning algorithm is a method by which a predetermined object device (e.g., a robot) is trained by using large numbers of learning data, to enable the predetermined object device to make its own decision or prediction. Examples of the learning algorithm may include supervised learning, unsupervised learning, semi-supervised learning or reinforcement learning, but the learning algorithm in the disclosure is not limited to the above example, unless explicitly stated otherwise. Hereafter, the at least one processor 130 is referred to as a processor 130 for convenience of description.

According to one embodiment, the electronic device 100 may receive various compressed images or images of various resolution. For example, the electronic device 100 may receive images in compressed forms such as Moving Picture Experts Group (MPEG; e.g., MP2, MP4, MP7 and the like), Joint Photographic Coding Experts Group (JPEG), Advanced Video Coding (AVC), H.264, H.265, High Efficiency Video Codec (HEVC) and the like. In another example, the electronic device 100 may receive any one of a Standard Definition (SD) image, a High Definition (HD) image, a Full HD image, and an Ultra HD image.

As one example, the processor 130 may acquire or obtain an output image by image-processing an input image. Herein, the image processing may include at least one of image enhancement, image restoration, image transformation, image analysis, image understanding, image compression, image decoding or scaling.

FIG. 2B is a block diagram illustrating one example of a configuration of an electronic device according to one or more embodiments.

Referring to FIG. 2B, an electronic device 100′ may include a display 110, memory 120, at least one processor 130, communication circuitry 140, a user interface 150, a sensor 160 and a speaker 170. Detailed description in relation to elements overlapping those illustrated in FIG. 2A, among the elements illustrated in FIG. 2B, is avoided.

The communication circuitry 140 may be implemented in various forms depending on embodiments of the electronic device 100′. For example, the communication interface (circuitry) 140 may perform communication with an external device, an external storage medium (e.g., USB memory), or an external server (e.g., webhard) and the like, based on a communication method such as Bluetooth, AP-based Wi-Fi (Wi-Fi, Wireless LAN network), Zigbee, wired/wireless Local Area Network (LAN), Wide Area Network (WAN), Ethernet, IEEE 1394, High-Definition Multimedia Interface (HDMI), Universal Serial Bus (USB), Mobile High-Definition Link (MHL), Audio Engineering Society/European Broadcasting Union (AES/EBU), Optical, Coaxial and the like. As one example, the communication circuitry 140 may perform communication with another electronic device, an external server and/or a remote control device and the like.

The user interface 150 may be implemented as a device such as a button, a touch pad, a mouse and a keyboard, or may be implemented as a touch screen capable of performing the above-described display function and manipulation input function together, and the like.

The sensor 160 may include various types of sensors such as a camera, a touch sensor, a proximity sensor, an acceleration sensor (or a gravity sensor), a geomagnetic sensor, a gyro sensor, a pressure sensor, a position sensor, a distance sensor, a luminance sensor and the like.

The speaker 170 may be an element outputting various types of notification sounds or voice messages and the like as well as various types of audio data. The processor 130 may control the speaker 170 such that feedbacks or various types of notification sounds according to the embodiments of the disclosure are output in an audio form.

In addition to the speaker, the electronic device 100′ may include a microphone and the like depending on embodiments.

The microphone is an element for receiving a user voice or other sounds and converting the same into audio data. However, according to another embodiment, the electronic device 100′ may receive a user voice input through an external device, through the communication circuitry 140.

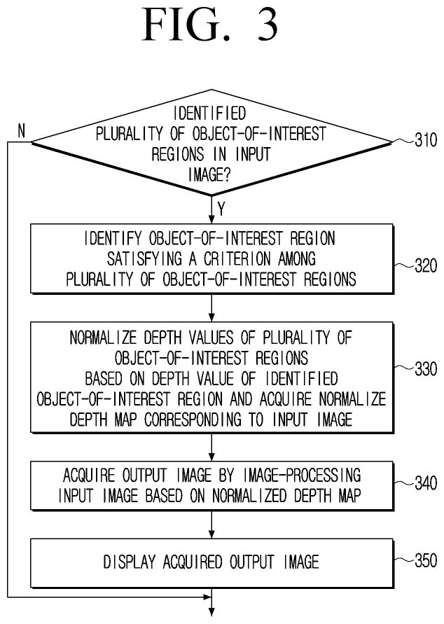

FIG. 3 is a flowchart provided to explain an example of a control method of an electronic device according to one embodiment.

Hereafter, each of the operations may be performed sequentially in the embodiments, but not necessarily performed sequentially. For example, the order of each of the operations may be changed, and at least two of the operations may be performed in parallel.

According to one embodiment, it may be understood that operations 310-350 are performed by the processor 130 of the electronic device 100.

Referring to FIG. 3, in operation 310, the method may include identifying a plurality of object-of-interest regions in the input image. For example, the electronic device 100 according to one embodiment may identify whether a plurality of object-of-interest regions is included in the input image. In the disclosure, the “region” denotes at least one pixel block or a collection of pixel blocks, as a term referring to one portion of an image. Additionally, the “pixel block” denotes a collection of adjacent pixels including at least one pixel. According to an embodiment, the object-of-interest region may be referred to as candidate regions. According to an embodiment, the method may include method may include identifying one or more objects, or one or more regions in the input image as the object-of-interest regions.

As one example, the electronic device 100 may identify whether a plurality of object-of-interest regions is included in an input image based on semantic segmentation information corresponding to the input image.

The semantic segmentation information may be information in which each pixel in an image is classified into a specific class. The specific class may include, but is not limited to, a person, sky, a tree, a vehicle and the like. As one example, the semantic segmentation information may be formed into a map including semantic information of each region of an image. The semantic segmentation map may be formed into a label indicating an object or a background to which each pixel of the image belongs. The label may include, but is not limited to, a color, an indicator, a flag, a text and the like. As one example, semantic segmentation may involve segmenting all objects belonging to an identical class in an identical manner, rather than segmenting an individual object. For example, in an image where there are persons, all the persons may be classified into an identical class of “person”. As one example, the semantic segmentation map may have the same resolution as an input image, and provide a precise classification based on a pixel unit.

As one example, the electronic device 100 may identify, as an object-of-interest region, a region identified as a pre-set class in the semantic segmentation map. For example, the class of “person” may be the pre-set class, but the disclosure is not limited thereto.

As one example, the electronic device 100 may acquire or obtain semantic segmentation information corresponding to an output image by using a first artificial intelligence model.

As one example, the first artificial intelligence model may allocate each pixel included in an image to a specific class. For example, in an image showing a road, each pixel may be classified into a class such as “person”, “road”, “vehicle”, “sky” and the like. For example, in the semantic segmentation map, each pixel may include a pre-defined class label. The class label may be information indicating which class is matched by the pixel in the image. In an example case in which the label is expressed as colors, the road may be expressed as gray, the vehicle may be expressed as red, and the pedestrian may be expressed as green.

As one example, the first artificial intelligence model may be implemented as a deep learning model using a convolutional neural network (CNN). For example, the first artificial intelligence model may be implemented as a fully convolutional network (FCN), U-Net, SegNet, DeepLab and the like. The first artificial intelligence model may learn features of an image and predict a class label most appropriate for each pixel.

However, the semantic segmentation information is not necessarily used to identify the plurality of object-of-interest regions, and another type of information may be used to identify the plurality of object-of-interest regions. For example, at least one of a background subtraction algorithm subtracting a background from an image or an object detection algorithm detecting a specific object may be used to identify the plurality of object-of-interest regions.

In an example case in which a plurality of object-of-interest regions are identified in an input image (310: Y), the method may include an operation 320 of identifying an object-of-interest region satisfying a criterion, among the plurality of object-of-interest regions. For example, the criterion may be minimum depth value, but the disclosure is not limited thereto. For example, the electronic device 100 according to one embodiment may identify an object-of-interest region having a minimum depth value among the plurality of object-of-interest regions.

As one example, the electronic device 100 may identify the object-of-interest region having the minimum depth value among the plurality of object-of-interest regions based on a depth map corresponding to the semantic segmentation map and the input image.

As one example, the electronic device 100 may input, to a second artificial intelligence model, an input image to acquire or obtain depth information including a depth value of each pixel included in the input image. For example, the depth information may be a depth map including relative depth information of each pixel. The relative depth information, as information indicating how far objects in an image are from a camera, may be based on a relative distance. The depth information may be provided based on a pixel unit, and the depth value of each pixel may denote a relative depth.

As one example, the second artificial intelligence model may be implemented as a deep learning model using a convolutional neural network (CNN). For example, the second artificial intelligence model may be implemented as a depth ordinal regression network (DORN), a pyramid stereo matching network (PSMNet), GC-Net, Midas, DenseDepth and the like.

As one example, the electronic device 100 may identify depth values corresponding to pixels included in the plurality of object-of-interest regions in the depth map based on position information of the plurality of object-of-interest regions identified in the semantic segmentation map. As one example, the electronic device 100 may identify a depth value histogram including a depth value distribution corresponding to each of the plurality of object-of-interest regions, based on the identified depth values of the pixels.

As one example, the electronic device 100 may identify a depth value corresponding to each of the plurality of object-of-interest regions based on the depth value histogram. For example, the electronic device 100 may identify an average depth value of each of the plurality of object-of-interest regions based on the depth value histogram, and identify the identified average depth value as a depth value corresponding to each of the plurality of object-of-interest regions.

However, the depth value histogram may not be necessarily used to identify the depth values of the regions of interest. For example, k-means clustering may be used to identify the depth value of the regions of interest. For example, the electronic device 100 may identify an input image as a plurality of regions and may form a cluster based on a representative depth value of each region, to identify the representative depth value as a depth value corresponding to each of the plurality of object-of-interest regions.

In operation 330, the method may include normalizing the depth values of the plurality of object-of-interest regions based on the depth value of the identified object-of-interest region and acquiring a normalized depth map corresponding to the input image based on the normalized depth values of the plurality of object-of-interest regions. For example, the electronic device 100 according to one embodiment may normalize, as an identical depth value, the depth values of the plurality of object-of-interest regions based on the depth value of the identified object-of-interest region, to acquire or obtain a normalized depth map corresponding to the input image. Ordinarily, the normalization of the depth values may denote performing re-definition by converting various types of depth information into an identical range (e.g., a value between 0 and 1). According to an embodiment of the disclosure, the term of normalization may be used in that the depth value of each region is re-defined such that a minimum depth value (e.g., a value “1”) among the depth values of the plurality of object-of-interest regions may be a maximum depth value in the image. However, the term “normalization” may be replaced with various terms such as conversion, adjustment, re-definition or relating.

As one example, the electronic device 100 may acquire a normalized depth map by normalizing, as an identical depth value, the depth values of the plurality of object-of-interest regions based on a minimum depth value among the depth values of the object-of-interest regions. For example, the electronic device 100 may acquire the normalized depth map by identically re-setting all the depth values of the plurality of object-of-interest regions as a minimum depth value among the depth values of the object-of-interest regions.

As one example, the electronic device 100 may acquire the normalized depth map by re-setting depth values of remaining regions except for the object-of-interest regions based on the normalized depth value.

For example, the normalized depth value may be a value corresponding to a minimum depth value among the depth values of the plurality of object-of-interest regions. For example, the normalized depth value may be a minimum depth value among the depth values of the plurality of object-of-interest regions or a value (e.g., “1”) as a result of converting the minimum depth value based on the pre-set criteria. In an example case in which the depth values of a first object of interest and a second object of interest are respectively “10” and “15”, the electronic device 100 may normalize the depth values of the first object of interest and the second object of interest based on the minimum value “10” out of “10” and “15”. For example, the electronic device 100 may convert the minimum value “10” to the value “1” pre-set for normalization, and may normalize the depth values of the first object of interest and the second object of interest as the value “1”.

As one example, the electronic device 100 may re-set, as a depth value identical with the normalized depth value, the depth value of a region of which a depth value is greater than the normalized depth value among the remaining regions expect for the object-of-interest regions. For example, assume that the depth values of a first object of interest and a second object of interest are respectively “10” and “15” while the depth value of a remaining background region is “20”. For example, the electronic device 100 may perform normalization as the value “1” based on the minimum value “10” out of the depths values “10” and “15” of the first object of interest and the second object of interest. For example, the electronic device 100 may re-set, as the value “1” identical with the depth values of the first object of interest and the second object of interest, the depth value of the remaining background region since the depth value of the remaining background region is “20” greater than “10”.

As one example, the electronic device 100 may re-set the depth value of a region of which a depth value is less than the normalized depth value among the remaining regions except for the object-of-interest regions, as a depth value identified based on a ratio of the depth value of the region to the normalized depth value. In an example case in which the depth values of the first object of interest and the second object of interest are respectively “10” and “15” while the depth value of the remaining background region is “5”, the electronic device 100 may normalize the depth values of the first object of interest and the second object of interest based on the minimum value “10” out of “10” and “15”. For example, the electronic device 100 may convert the minimum value “10” to the value “1” pre-set for normalization, normalize the depth values of the first object of interest and the second object of interest to the value “1”, and re-set, as “5/10=0.5” (“the depth value of the remaining background region/the minimum depth value among the depth values of the objects of interest”), the depth value of the remaining background region.

In operation 340, the method may include acquiring or obtaining output image by image-processing the input image based on the normalized depth map. For example, the electronic device 100 according to one embodiment may acquire an output image by image-processing the input image based on the normalized depth map.

As one example, the electronic device 100 may acquire the output image by image-enhancing the input image based on the normalized depth map. For example, the electronic device 100 may acquire the output image by differentially processing at least one of the contrast, saturation or sharpness of the input image for each region, based on the normalized depth map. For example, the electronic device 100 may acquire the output image by performing at least one image processing among noise reduction, detail enhancement, tone mapping, contrast enhancement or color enhancement or frame rate conversion, based on the normalized depth map.

In operation 350, the method may include displaying the acquired output image on the display 110. For example, the electronic device 100 according to one embodiments may display the acquired output image on the display 110.

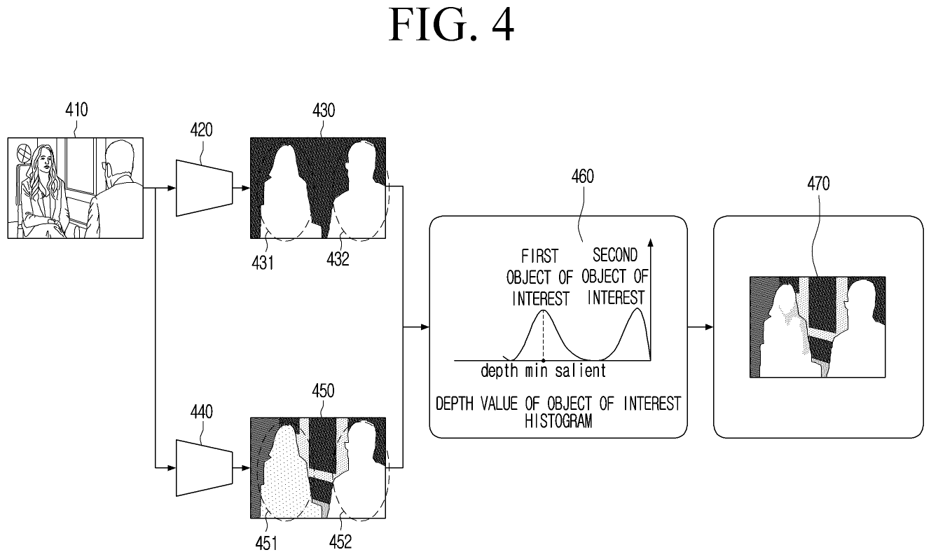

FIG. 4 is a view provided to explain an acquisition method of a normalized depth map according to one embodiment.

According to one embodiment, the electronic device 100 may acquire object-of-interest information and depth information corresponding to the input image, and may acquire a normalize depth map based on the object-of interest information and the depth information.

As one example illustrated in FIG. 4, the electronic device 100 may acquire object-of-interest information 430 by inputting an input image 410 to a first artificial intelligence model 420. For example, the object-of-interest information 430 may be semantic segmentation information, but not limited thereto.

As one example, the electronic device 100 may acquire relative depth information 450 by inputting the input image 410 to a second artificial intelligence model 440. For example, the relative depth information 450 may be a depth map including relative depth information of each pixel.

As one example, the electronic device 100 may identify an object-of-interest region having a minimum depth value among a plurality of object-of-interest regions included in the input image 410, based on the object-of-interest information 430 and the relative depth information 450.

As one example, based on pixel position information of a plurality of object-of-interest regions 431, 432 identified in the object-of-interest information 430, the electronic device 100 may identify depth values 451, 452 corresponding to pixels included in the plurality of object-of-interest regions in the relative depth information 450. As one example, the electronic device 100 may identify a depth value histogram 460 including a depth value distribution corresponding to each of the plurality of object-of-interest regions based on the identified depth values of the pixels.

As one example, the electronic device 100 may identify a depth value corresponding to each of the plurality of object-of-interest regions based on the depth value histogram 460. For example, the electronic device 100 may identify an average depth value of the plurality of object-of-interest regions (e.g., first object of interest and second object of interest) based on the depth value histogram 460, and may identify the identified average depth value as a depth value corresponding to each of the plurality of object-of-interest regions. For example, the electronic device 100 may define each of the plurality of object-of-interest regions as a mode, and may calculate an average depth value of modes having a minimum depth value among modes.

As one example, the electronic device 100 may acquire a normalized depth map 470 corresponding to the input image by normalizing the depth values of the plurality of object-of-interest regions and the depth values of the remaining regions based on the identified minimum depth value.

As one example, the electronic device 100 may normalize the depth value of each region based on Equation (1)

Depth_norm=clipping (depth/(depth_min_salient), 1) (1)

Depth_min_salient may be an average depth value of modes corresponding to a minimum depth value among the modes corresponding to the object-of-interest regions.

For example, the electronic device 100 may clip a depth value greater than depth_min_salient to 1 and may clip a depth value less than depth_min_salient to depth/(depth_min_salient) to calculate a normalized depth value, based on Equation (1). The depth value clipping may be a process of limiting depth values to values in a specific range.

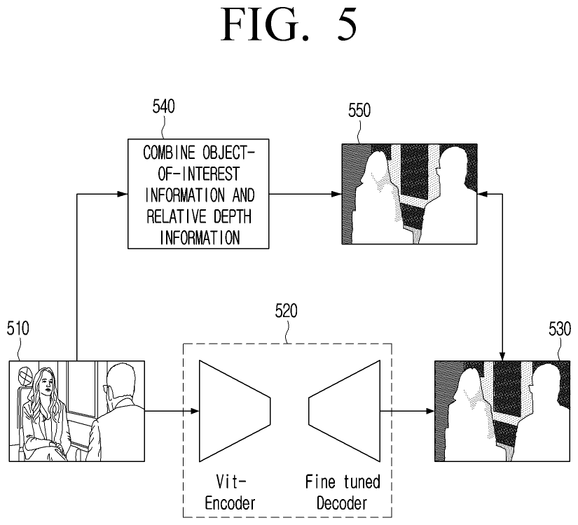

FIG. 5 is a view provided to explain an acquisition method of a normalized depth map according to one embodiment.

According to one embodiment, the electronic device 100 may acquire a normalized depth map by using a third artificial intelligence model trained to acquire a normalized depth map corresponding to an input image. As one example, the third artificial intelligence model maybe trained to identify an object-of-interest region having a minimum depth value among a plurality of object-of-interest regions identified in an input image, and based on the minimum depth value of the identified object-of-interest region, normalize depth values of the plurality of object-of-interest regions as an identical depth value, and output a normalized depth map.

As one example illustrated in FIG. 5, the electronic device 100 may acquire a normalized depth map 530 by inputting an input image 510 to a third artificial intelligence model 520.

As one example, the third artificial intelligence model 520 may be trained by using, as ground truth, normalized depth information 550 acquired by combining 540 object-of-interest information and relative depth information.

As one example, the third artificial intelligence model 520 may include an encoder and a decoder. For example, the third artificial intelligence model 520 may have an encoder-decoder structure allowing of end-to-end learning. For example, the third artificial intelligence model 520 may extract important features from the input image, and based on the extracted features, may generate a depth map.

As on example, the encoder may perform a vision image transform (e.g., a Vit encoder) and may be pre-trained based on unsupervised learning. As one example, the decoder may use the normalized depth information 550 as ground truth for training. For example, the decoder (e.g., a fine tuned decoder) may be trained to minimize loss between the ground truth and a predicted value. For example, the ground truth may be used as a criteria for evaluating the predicted value as an object value for the third artificial intelligence model 520 to predict, and the loss may be calculated based on a difference between the ground truth and the predicted value.

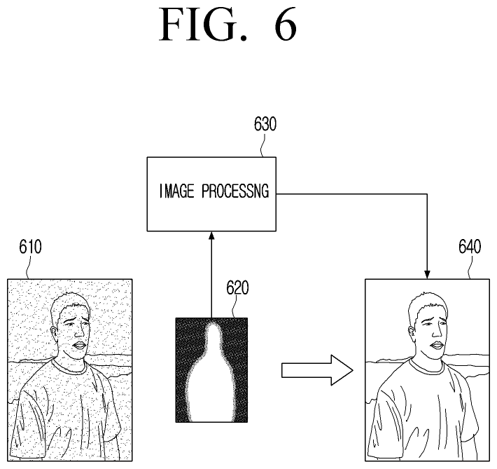

FIG. 6 is a view provided to explain an image processing method using normalized depth information according to one embodiment.

According to one embodiment, the electronic device 100 may acquire an output image by image-processing an input image based on a normalized depth map.

As one example illustrated in FIG. 6, in an example case in which a normalized depth map 620 is acquired based on an input image 610, the electronic device 100 may control image processing Intellectual Property (IP) 630 to image-process the input image 610 based on the normalized depth map 620 to acquire an output image 640.

As one example, the image processing IP 630 may be a hardware chip or a software technology specializing in image processing for improving or optimizing the quality of an image. For example, the electronic device 100 may control image processing IP 630 to perform at least one of resolution enhancement, detail enhancement, denoising, HDR processing, color correction, contrast enhancement, edge enhancement, color grading, and saturation adjustment, based on the normalized depth map 620.

As one example, the electronic device 100 may perform image processing differentially for each region according to an aerial perspective theory based on the normalized depth map 620. The aerial perspective theory relates to an interaction between fine particles (e.g., dust, droplets) and light that exist in the air. For example, a far object has a visual feature different from that of a close object as light having passed through the air further reaches the eye of the observer. For example, the image processing IP 630 may be performed such that the close object has relatively high saturation and/or sharpness while the far object has relatively low saturation and/or sharpness. For example, the closer object has a higher saturation and/or a higher sharpness than the far object.

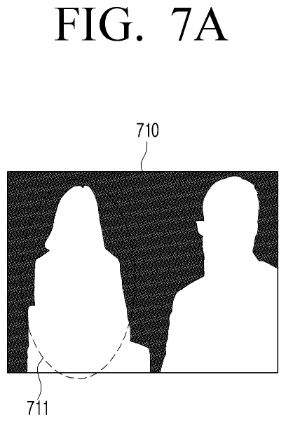

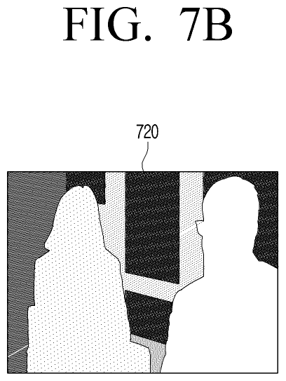

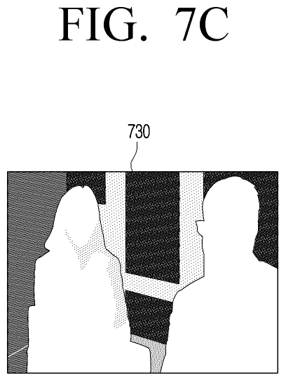

FIGS. 7A,7B and 7C are views provided to explain an image processing effect using normalized depth information according to one embodiment.

FIG. 7A and FIG. 7B may be object-of-interest information 710 and relative depth information 720 corresponding to the input image as one example illustrated in FIG. 1A.

As one example, the electronic device 100 may identify an object of interest 711 having a minimum depth value based on the object-of-interest information 710 and the relative depth information 720, and based on the identified minimum depth value, may acquire the normalized depth information 730 as illustrated in FIG. 7C. In this case, according to the normalized depth information 730, depth values of the foreground object and the background object may be normalized as an identical depth value. Accordingly, the foreground object and the background object are image-processed at an identical weight value, maintaining the intention of the producer.

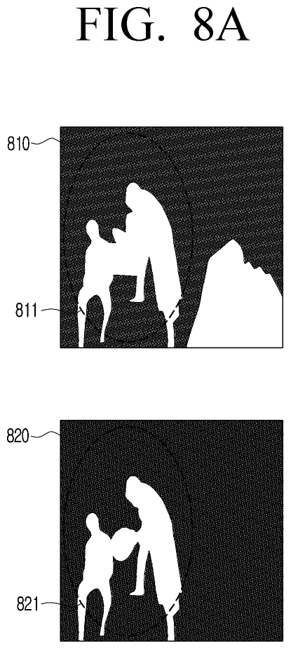

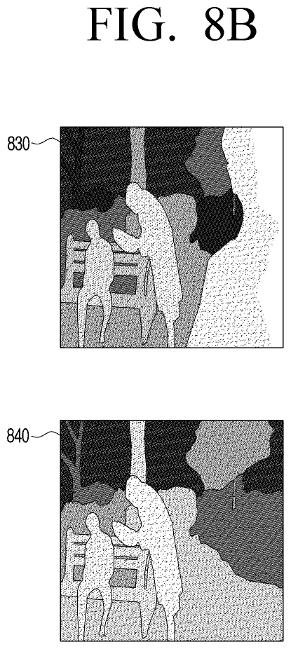

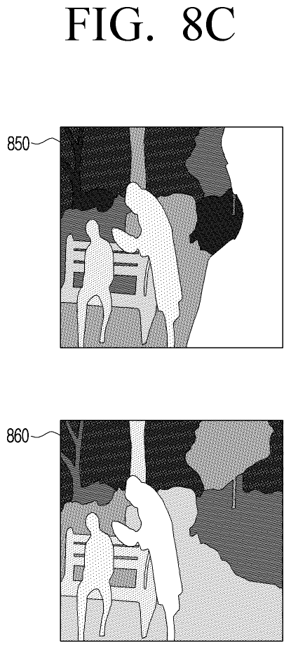

FIGS. 8A, 8B and 8C are views provided to explain an image processing effect using normalized depth information according to one embodiment.

FIG. 8A and FIG. 8B show object-of-interest information 810, 820 and relative depth information 830, 840 that correspond to a plurality of input frames according to one embodiment illustrated in FIG. 1B.

As one example, the electronic device 100 may identify an object of interest 811, 821 having a minimum depth value based on the object-of-interest information 810, 820 and relative depth information 830, 840, and based on the identified minimum depth value, may obtain normalized depth information 850, 860 corresponding to each of the plurality of input frames as illustrated in FIG. 8C. In this case, according to the normalized depth information 730, a foreground object and a background object may be normalized to have an identical depth value. Accordingly, image processing may be performed for an identical object of interest 811, 821 on an identical scene at an identical weight value, maintaining identical image quality.

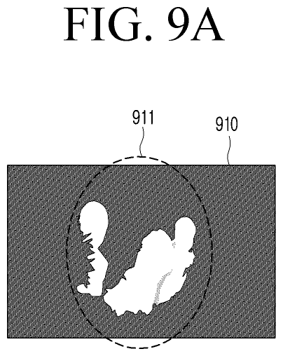

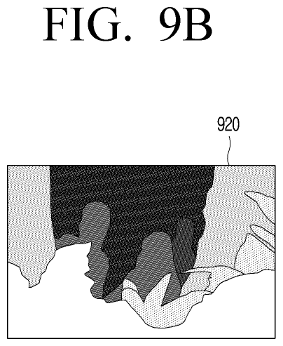

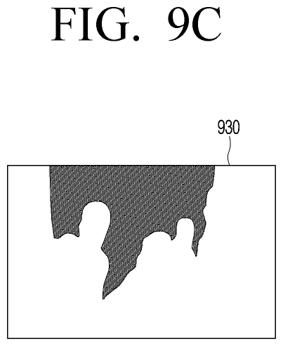

FIGS. 9A, 9B and 9C are views provided to explain an image processing effect using normalized depth information according to one embodiment.

FIG. 9A and FIG. 9B show object-of-interest information 910 and relative depth information 920 that correspond to an input image according to one embodiment illustrated in FIG. 1C.

As one example, the electronic device 100 may identify an object of interest 911 having a minimum depth value based on the object-of-interest information 910 and relative depth information 920, and based on the identified minimum depth value, may obtain normalized depth information 930 as illustrated in FIG. 9C. In this case, according to the normalized depth information 930, a foreground object and a background object may be normalized to have an identical depth value. Accordingly, since the foreground object and the background object are image-processed at an identical weight value, the object of interest in the background is emphasized further than the foreground, causing no cognitive dissonance in which a relative depth value is inverted.

According to the above-described embodiments, as image processing IP (e.g., contrast, saturation, sharpness) may be controlled differentially based on a depth value, a difference between a foreground and a background may be intensified, securing improvement in three dimensionality.

Each of the operations according to the embodiments may be performed by the processor 110, but when necessary, a module for each operation may be used. For example, modules may respectively be implemented by at least one software, at least one hardware and/or a combination thereof. Each of the modules may be implemented to use a pre-defined algorithm, a pre-defined formula and/or a trained artificial intelligence model, to perform an operation. However, at least part of the modules may be distributed in an external device.

The methods according to the embodiments described above may be implemented in the form of an application that is installable in an existing electronic device. In another example, the methods according to the embodiments described above may be performed by using an artificial neural network based on deep learning (or a deep artificial neural network), e.g., a trained network model.

The methods according to the embodiments described above may be implemented simply by upgrading the software or hardware of an existing electronic device.

The embodiments described above may be implemented through an embedded server provided in an electronic device, or an external server of an electronic device.

The embodiments described above may be implemented with software including instructions stored in a storage medium readable by a machine (e.g., a computer). The machine, as a device capable of calling the stored instructions from the storage medium and operating according to the called instructions, may include an electronic device (e.g., electronic device A) according to the disclosed embodiments. Based on instructions executed by a processor, the processor may perform functions corresponding to the instructions directly or by using other elements under the control of the processor. The instructions may include a code generated or executed by a compiler or an interpreter. The machine-readable storage medium may be provided in the form of a non-transitory storage medium. Herein, the term “non-transitory” means that the storage medium does not include a signal and only means that the storage medium is tangible, while the term does not differentiate semi-permanent or temporary storage of data in the storage medium.

According to the embodiments described above, the methods may be provided in a computer program product. The computer program product may be exchanged between a seller and a purchaser as a commodity. The computer program product may be distributed in the form of a machine-readable storage medium (e.g., compact disc read only memory (CD-ROM)) or distributed online through an application store (e.g., Play Store™). In an example case in which the computer program product is distributed online, at least part of the computer program product may be stored at least temporarily, or generated temporarily in a storage medium such as a server of a manufacturer, a server of an application store, or memory of a relay server.

Further, each of the elements (e.g., a module or a program) according to the embodiments described above may be included of a single entity or a plurality of entities, and some of the corresponding sub elements described above may be omitted, or another sub element may be further included in the embodiments. Alternatively or additionally, some of the elements (e.g., modules or programs) may be integrated into one entity to perform identical or similar functions performed by each corresponding element prior to integration. Operations performed by a module, a program, or another element, according to the embodiments, may be executed sequentially, in parallel, repetitively, or heuristically, or at least some of the operations may be executed in a different order, omitted, or may add a different operation.

While example embodiments of the disclosure are illustrated and described above, embodiments of the disclosure are not limited to specific embodiments set forth herein, and certainly, various modifications thereof may be made by those skilled in the art to which the disclosure pertains, without departing from the scope the disclosure claimed in the section of claims, and should not be understood as separating from the technical spirit or prospect of the disclosure.

What is claimed is:

1. An electronic device comprising:
a display;
memory storing instructions; and
at least one processor,
wherein the instructions, when executed by the at least one processor individually or collectively, cause the electronic device to:
identify a first object-of-interest region having a minimum depth value among a plurality of object-of-interest regions identified in an input image;
normalize depth values of the plurality of object-of-interest regions based on a first depth value of the first object-of-interest region, and acquire a normalized depth map corresponding to the input image based on the normalized depth values of the plurality of object-of-interest regions;
acquire an output image by image-processing the input image based on the normalized depth map; and
display the acquired output image on the display.

2. The electronic device as claimed in claim 1, wherein the instructions, when executed by the at least one processor individually or collectively, further cause the electronic device to:
acquire the first depth value of the first object-of-interest region based on a minimum depth value of the first object-of-interest region, and
acquire the normalized depth map by re-setting depth values of remaining regions except for the first object-of-interest region based on the normalized depth values.

3. The electronic device as claimed in claim 1, wherein the instructions, when executed by the at least one processor individually or collectively, further cause the electronic device to:
acquire the normalized depth map by re-setting, as a depth value identical with the depth values of the plurality of object-of-interest regions, a depth value of a region of which a depth value is greater than the minimum depth value among the remaining regions.

4. The electronic device as claimed in claim 1, wherein the instructions, when executed by the at least one processor individually or collectively, further cause the electronic device to:
acquire the normalized depth map by re-setting, as a depth value identified based on a ratio of a depth value of a region of which a depth value is less than the minimum depth value among the remaining regions to the minimum depth value, the depth value of the region.

5. The electronic device as claimed in claim 1, wherein the instructions, when executed by the at least one processor individually or collectively, further cause the electronic device to:
acquire a semantic segmentation map comprising pixel position information corresponding to the plurality of object-of-interest regions by inputting the input image to a first artificial intelligence model;
acquire a depth map comprising a depth value of each pixel in the input image by inputting the input image to a second artificial intelligence model; and
identify the first object-of-interest region having the minimum depth value among the plurality of object-of-interest regions based on the semantic segmentation map and the depth map.

6. The electronic device as claimed in claim 5, wherein the instructions, when executed by the at least one processor individually or collectively, further cause the electronic device to:
identify object-of-interest depth values corresponding to pixels in the plurality of object-of-interest regions in the depth map, based on the pixel position information of the plurality of object-of-interest regions identified in the semantic segmentation map;
identify a depth value histogram comprising a depth value distribution corresponding to each of the plurality of object-of-interest regions based on the object-of-interest depth values; and
identify a depth value corresponding to each of the plurality of object-of-interest regions based on the depth value histogram.

7. The electronic device as claimed in claim 6, wherein the instructions, when executed by the at least one processor individually or collectively, further cause the electronic device to:
identify an average depth value of each of the plurality of object-of-interest regions based on the depth value histogram; and
identify, as the depth value corresponding to each of the plurality of object-of-interest regions, the respective average depth value.

8. The electronic device as claimed in claim 1, wherein the instructions, when executed by the at least one processor individually or collectively, further cause the electronic device to:
acquire the normalized depth map by inputting the input image to a third artificial intelligence model, and
wherein the third artificial intelligence model is trained to identify an object-of-interest region having a minimum depth value among a plurality of object-of-interest regions identified in the input image, to normalize the depth values of the plurality of object-of-interest regions based on the minimum depth value of the first object-of-interest region, and to output the normalized depth map.

9. The electronic device as claimed in claim 1, wherein the instructions, when executed by the at least one processor individually or collectively, further cause the electronic device to:
acquire the output image by differentially processing at least one of contrast, saturation or sharpness of the input image for each region based on the normalized depth map.

10. A control method of an electronic device, the method comprising:
identifying a first object-of-interest region having a minimum depth value among a plurality of object-of-interest regions identified in an input image;
normalizing depth values of the plurality of object-of-interest regions based on a first depth value of the first object-of-interest region, and acquiring a normalized depth map corresponding to the input image based on the normalized depth values of the plurality of object-of-interest regions;
acquiring an output image by image-processing the input image based on the normalized depth map; and
displaying the acquired output image on a display.

11. The method as claimed in claim 10, wherein the acquiring the normalized depth map comprises:
acquiring the first depth value of the first object-of-interest region based on a minimum depth value of the first object-of-interest region, and
acquiring the normalized depth map by re-setting depth values of remaining regions except for the first object-of-interest region based on the normalized depth values.

12. The method as claimed in claim 10, wherein the acquiring the normalized depth map comprises:
acquiring the normalized depth map by re-setting, as a depth value identical with the depth values of the plurality of object-of-interest regions, a depth value of a region of which a depth value is greater than the minimum depth value among the remaining regions.

13. The method as claimed in claim 10, wherein the acquiring the normalized depth map comprises:
acquiring the normalized depth map by re-setting, as a depth value identified based on a ratio of a depth value of a region of which a depth value is less than the minimum depth value among the remaining regions to the minimum depth value, the depth value of the region.

14. The method as claimed in claim 10, the identifying the object-of-interest region having a minimum depth value comprises:
acquiring a semantic segmentation map comprising pixel position information corresponding to the plurality of object-of-interest regions by inputting the input image to a first artificial intelligence model;
acquiring a depth map comprising a depth value of each pixel in the input image by inputting the input image to a second artificial intelligence model; and
identifying the object-of-interest region having the minimum depth value among the plurality of object-of-interest regions based on the semantic segmentation map and the depth map.

15. The method as claimed in claim 14, wherein the identifying the object-of-interest region having a minimum depth value comprises:
identifying object-of-interest depth values corresponding to pixels in the plurality of object-of-interest regions in the depth map, based on the pixel position information of the plurality of object-of-interest regions identified in the semantic segmentation map;
identifying a depth value histogram comprising a depth value distribution corresponding to each of the plurality of object-of-interest regions based on the object-of-interest depth values; and
identifying a depth value corresponding to each of the plurality of object-of-interest regions based on the depth value histogram.

16. The method as claimed in claim 15, wherein the identifying a depth value corresponding to each of the plurality of object-of-interest regions comprises:
identifying an average depth value of each of the plurality of object-of-interest regions based on the depth value histogram; and
identifying, as the depth value corresponding to each of the plurality of object-of-interest regions, the respective average depth value.

17. The method as claimed in claim 10, wherein the acquiring the normalized depth map comprises:
acquiring the normalized depth map by inputting the input image to a third artificial intelligence model, and
wherein the third artificial intelligence model is trained to identify an object-of-interest region having a minimum depth value among a plurality of object-of-interest regions identified in the input image, to normalize the depth values of the plurality of object-of-interest regions based on the minimum depth value of the first object-of-interest region, and to output the normalized depth map.

18. The method as claimed in claim 10, wherein the acquiring the output image:
acquiring the output image by differentially processing at least one of contrast, saturation or sharpness of the input image for each region based on the normalized depth map.

19. A non-transitory computer readable medium storing computer instructions, wherein the instructions, when executed by a processor of an electronic device, cause the electronic device to perform operations, the operations comprising:
identifying a first object-of-interest region having a minimum depth value among a plurality of object-of-interest regions identified in an input image;
normalizing depth values of the plurality of object-of-interest regions based on a first depth value of the first object-of-interest region, and acquiring a normalized depth map corresponding to the input image based on the normalized depth values of the plurality of object-of-interest regions;
acquiring an output image by image-processing the input image based on the normalized depth map; and
displaying the acquired output image on a display.

20. The non-transitory computer readable medium as claimed in claim 19, wherein the acquiring the normalized depth map comprises:
acquiring the first depth value of the first object-of-interest region based on a minimum depth value of the first object-of-interest region, and
acquiring the normalized depth map by re-setting depth values of remaining regions except for the first object-of-interest region based on the normalized depth values.
